(19) United States
(12) Patent Application Publication
(10) Pub. No.: US 2023/0140916 A1
(43) Pub. Date: May 11, 2023

(54) METHOD FOR VALIDATING AN ASSIGNMENT OF LABELS TO ORDERED SEQUENCES OF WEB ELEMENTS IN A WEB PAGE

(71) Applicant: Klarna Bank AB, Stockholm (SE)

(72) Inventors: David Buezas, Berlin (DE); Riccardo Sven Risuleo, Stockholm (SE)

(21) Appl. No.: 17/967,817

(22) Filed: Oct. 17, 2022

Related U.S. Application Data
(60) Provisional application No. 63/273,822, filed on Oct. 29, 2021.
(60) Provisional application No. 63/273,824, filed on Oct. 29, 2021.
(60) Provisional application No. 63/273,852, filed on Oct. 29, 2021.

(51) Int. Cl. G06F 40/174; G06F 40/143

(52) U.S. Cl. CPC G06F 40/174; G06F 40/143

(57) ABSTRACT

A dataset of classification orderings is created based on previously observed interface elements in interfaces of third-party interface providers. A request to evaluate a sequence of predicted classifications is received. The dataset is queried to determine a value derived from a frequency of the sequence of predicted classifications occurring in the dataset. A client device is caused, by responding to the request with the value, to autocomplete input to a plurality of elements corresponding to the sequence of predicted classifications if the value reaches a value relative to a threshold cause.

### CROSS REFERENCE TO RELATED APPLICATION

This application claims the benefit of U.S. Provisional Pat. Application No. 63/273,822, filed Oct. 29, 2021, entitled “SYSTEM FOR IDENTIFICATION OF WEB ELEMENTS IN FORMS ON WEB PAGES,” U.S. Provisional Pat. Application No. 63/273,824, filed Oct. 29, 2021, entitled “METHOD FOR VALIDATING AN ASSIGNMENT OF LABELS TO ORDERED SEQUENCES OF WEB ELEMENTS IN A WEB PAGE,” and U.S. Provisional Pat. Application No. 63/273,852, filed Oct. 29, 2021, entitled “EFFICIENT COMPUTATION OF MAXIMUM PROBABILITY LABEL ASSIGNMENTS FOR SEQUENCES OF WEB ELEMENTS,” the disclosures of which are herein incorporated by reference in their entirety.

This application incorporates by reference for all purposes the full disclosure of co-pending U.S. Pat. Application No. ______, filed concurrently herewith, entitled “SYSTEM FOR IDENTIFICATION OF WEB ELEMENTS IN FORMS ON WEB PAGES” (Attorney Docket No. 0101560-023US0), and co-pending U.S. Pat. Application No. ______, filed concurrently herewith, entitled “EFFICIENT COMPUTATION OF MAXIMUM PROBABILITY LABEL ASSIGNMENTS FOR SEQUENCES OF WEB ELEMENTS” (Attorney Docket No. 0101560-025US0).

### BACKGROUND

Automatic form filling is an attractive way of improving a user’s experience while using an electronic form. Filling in the same information, such as name, email address, phone number, age, credit card information, and so on, in different forms on different websites over and over again can be quite tedious and annoying. Forcing users to complete forms manually can result in users giving up in frustration or weariness and failing to complete their registration or transaction.

Saving once filled in form information for reusing it later when new forms are encountered on newly visited websites, however, presents its own set of problems. Since websites are built in numerous different ways (e.g., using assorted web frameworks), it is difficult to automatically identify the field classes in order to map the fields to the correct form information for that field class. Furthermore, some websites take measures to actively confuse browsers so they do not memorize entered data. For instance, a form-filling system needs to detect whether a web page includes forms, identify the kind of form-fields within it, and decide on the information (from the previously filled in and stored list) that should be provided. However, these all look different depending on the information required from the user, the web frameworks used, and the particular decisions taken by its implementers.

### BRIEF DESCRIPTION OF THE DRAWINGS

Various techniques will be described with reference to the drawings, in which:

FIG. 1 illustrates an example of a form-filling system in accordance with an embodiment;

FIG. 2 illustrates an example of a form prediction verification system in accordance with an embodiment;

FIG. 3 illustrates an example of a local assignment module trained in accordance with an embodiment;

FIG. 4 illustrates an example of a sequence assignment module trained in accordance with an embodiment;

FIG. 5 illustrates an example of predictions made by a sequence assignment module in accordance with an embodiment;

FIG. 6 is a flowchart that illustrates an example of field sequence verification in accordance with an embodiment; and

FIG. 7 illustrates a computing device that may be used in accordance with at least one embodiment.

### DETAILED DESCRIPTION

Techniques and systems described below relate to solutions for problems of evaluating the accuracy of identification of web elements in a form. In one example, for each form of a plurality of forms containing one or more form-fields where each of the one or more form-fields of the form corresponds to a field category, the form is evaluated to determine an ordering of classifications of the one or more form-fields and the ordering of classifications is stored in a dataset of previously observed form-field category orderings. In the example, information is obtained that indicates predicted classifications of a set of form-fields of a third-party interface and an ordering of the set of form-fields. Further in the example, a probability of the predicted classifications being correct is determined based on the information and the dataset of previously observed form-field category orderings. Lastly in the example, as a result of the probability reaching a value relative to a threshold, an indication of confidence whether the predicted classifications are correct is provided to a software application on a client device.

In an embodiment, the system of the present disclosure receives a set of predictions for a form on a web page. If the form elements have been evaluated in isolation, various mistakes can occur; such as multiple fields predicted to be the same element class (e.g., two fields identified as “first name” fields, etc.) or improbable sequences of form elements (e.g., surnames preceding a first name, a zip code following a telephone number field, a telephone number field preceding an address field, a password field following a middle initial field, etc.). Form-fields tend to be ordered in a sequence that humans are used to, and consequently the system of the present disclosure utilizes information based on observed sequences of actual form-fields to determine whether form-field predictions are likely correct or not. For example, given a prediction of a surname field followed by a first name field, the system of the present disclosure may compute a probability of those fields appearing in that sequence based on the sequences of fields in all of the forms it has observed in training data.

In the preceding and following descriptions, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially the field of electronic form filling, by validating that form-field predictions are correct before filling out the form-fields. Additionally, techniques described and suggested in the present disclosure improve the efficiency of electronic form-filling and improving user experience by enabling users to quickly complete and submit electronic forms with minimal user input. Moreover, techniques described and suggested in the present disclosure are necessarily rooted in computer technology in order to overcome problems specifically arising with identifying form elements based on their individual features by calculating a probability of the form element identifications being correct based on their sequence.

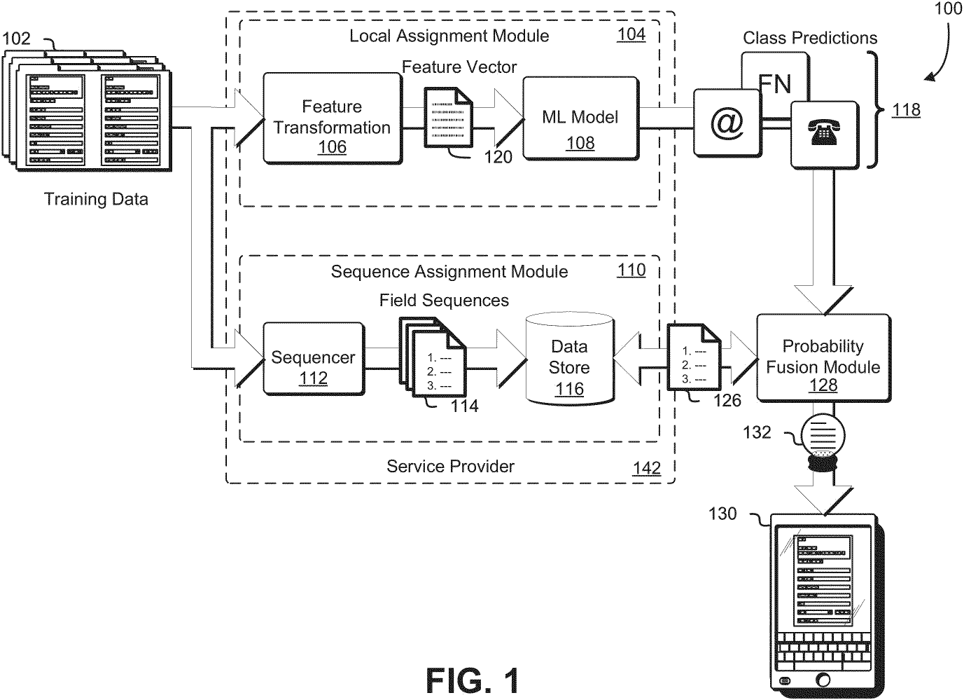

FIG. 1 illustrates an example embodiment 100 of the present disclosure. Specifically, FIG. 1 depicts a system whereby a set of training data 102 is used to train a machine learning model 108 of a local assignment module 104. The training data 102 may be provided to a feature transformation submodule 106 that transforms the training data 102 into feature vectors 120, which may be used to train the machine learning model 108 to produce the class predictions 118 based on field features. The training data 102 may also be provided to a sequence assignment module 110; for example, the training data 102 may be provided to a sequencer 112 module which identifies the field sequences 114 of fields in each form of the training data 102. The sequences may be stored in the data store 116, whereby they may be retrieved later by the sequence assignment module 110 in determination of a sequence confidence scores 126 for a particular form being analyzed. For a particular form being analyzed, the class predictions 118 of the form-fields as output from the local assignment module 104 and the sequence confidence scores 126 may be input to a probability fusion module 128, which may output the classification assignment 132 for form filling.

In embodiments of the present disclosure, the system combines information of each element (i.e., the local features) in an interface together with the sequencing information about element ordering to provide an improved estimate of the probability of any label assignment. The system may be comprised of three components/modules, the local assignment module 104, the sequence assignment module 110 and the probability fusion module 128. Note, that the use of “probability” in the context of the present disclosure may not necessarily refer to a statistical likelihood (e.g., the probability (density) of observations given a parameter). Rather, in some examples “probability” refers to an unnormalized probability (e.g., a relative score) that reflects mutual preferences between alternatives. The probabilities produced by the local assignment module 104, for example, can be compared with each other to determine which class, in Bayesian interpretation, is more probable and therefore more preferable. The mathematics used to generate the probabilities of the present disclosure may be similar to the rules of probability theory (but may lack a normalization constant; hence the term, “unnormalized probability”). Note, however, that it is contemplated that techniques of the present disclosure are usable with different scoring methods to indicate preference that may produce values not strictly regarded as unnormalized probabilities.

The local assignment module 104 may be a hardware or software module that obtains information about elements of interest as inputs and, in return, outputs confidence scores for the elements belonging to a class from a predefined vocabulary of classes. In embodiments, the local assignment module 104 is similar to the local assignment module described in U.S. Pat. Application No. ______, entitled “SYSTEM FOR IDENTIFICATION OF WEB ELEMENTS IN FORMS ON WEB PAGES” (Attorney Docket No. 0101560-023US0), incorporated herein by reference.

The local assignment module 104 may be trained in a supervised manner to, for an element of interest, return confidence scores for the element belonging to each class of interest from predefined classes of interest (e.g., name field, zip code field, city field, etc.) based on the information about element of interest (e.g., a tag, attributes, text contained within the element source code and immediate neighboring text elements, etc.). In some examples, an “element of interest” refers to an element of an interface that is identified as having potential to be an element that falls within a class of interest. In some examples, an “element” refers to an object incorporated into an interface, such as a HyperText Markup Language (HTML) element.

Examples of elements of interest include HTML form elements (e.g., INPUT elements), list elements, or other HTML elements, or other objects occurring within an interface. In some examples, a “class of interest” refers to a particular class of element that an embodiment of the present disclosure is trained or being trained to identify. Examples of classes of interest include name fields (e.g., first name, middle name, last name, etc.), surname fields, cart button, total amount field, list item element, or whatever element is suitable to use with the techniques of the present disclosure as appropriate to the implemented embodiment. Further details about the local assignment module may be found in U.S. Pat. Application No. ______, entitled “SYSTEM FOR IDENTIFICATION OF WEB ELEMENTS IN FORMS ON WEB PAGES” (Attorney Docket No. 0101560-023US0), incorporated herein by reference. Information about the element of interest may include tags, attributes, or text contained within the source code of the element of interest. Information about the element of interest may further include tags, attributes, or text contained within neighboring elements of the element of interest.

The sequence assignment module 110 may be a hardware or software module that obtains information about the ordering (i.e., sequence) of elements of interest and may use this sequencing information from the ordering of fields to output the probability of each element of interest belonging to each of the predefined classes of interest. The field ordering may be left-to-right ordering in a rendered web page or a depth-first traversal of a DOM tree of the web page; however, it is contemplated that the techniques described in the present disclosure may be applied to other orderings (e.g., top-to-bottom, right-to-left, pixel-wise, largest-to-smallest, smallest-to-largest, etc.) as needed for the region or particular implementation of the system. The sequence assignment module 110 may be similar to the sequence assignment module described in U.S. Pat. Application No. ______, entitled “EFFICIENT COMPUTATION OF MAXIMUM PROBABILITY LABEL ASSIGNMENTS FOR SEQUENCES OF WEB ELEMENTS” (Attorney Docket No. 0101560-025US0), incorporated herein by reference.

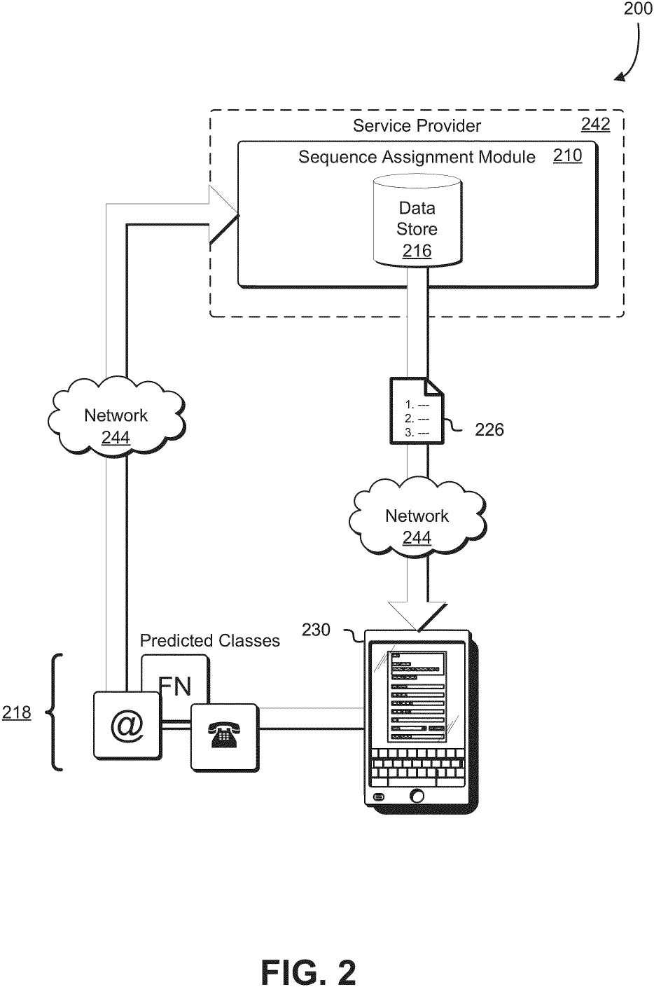

The probability produced by the sequence assignment module 110 may reflect the probability of the predicted elements being correct based on a frequency that such elements have been observed to occur in that order in the set of training data 102. For example, if the local assignment module 104 outputs the class predictions 118 that predict elements of first name, surname, password, shipping address, in that order, in an interface, the sequence assignment module 110 may receive that ordering information as input and, in return, output a value reflecting the frequency of those elements occurring in that order in the set of training data 102. The higher the frequency, the more likely the class predictions are to be correct. Further details about the sequence assignment module may be found in the descriptions of FIGS. 2-6.

In an example, suppose that the local assignment module 104 and the sequence assignment module 110 have been trained, and we want to find the probability of any possible assignment of labels [labi, ..., lab_{M}] from a vocabulary of possible classes [clsi, ..., cls_{K}] that the system was trained on given a new sequence of elements [eli, ..., el_{M}]. In the example, the local assignment module 104 returns a table of confidence scores p(labⱼ\elᵢ) for possible class labels for each element in the sequence. In some embodiments, the confidence scores are probabilities between 0 and 1 (1 being 100%). In some examples, a “label” refers to an item being predicted by a machine learning model or the item the machine learning model is being trained to predict (e.g., a y variable in a linear regression). In some examples, a “feature” refers an input value derived from a property (also referred to as an attribute) of data being evaluated by a machine learning model or being used to train the machine learning model (e.g., an x variable in a linear regression). A set of features corresponding to a single label may be stored in one of many columns of each record of a training set, such as in rows and columns of a data table. In the example, the sequence assignment module 110 returns a table of confidence scores p(labᵢ| lab_{0..i-1}) of possible class labels for each element, given the labels of the elements above.

Then, in the example, the probability fusion module combines the two probabilistic predictions and returns a probability of the full assignment, for example, using Bayes’ theorem:

$$p \left(l a {b}_{1} , … , l a {b}_{M} \left|e {l}_{1} , … , e {l}_{M}\right)\right) = \frac{p \left(e {l}_{M} \left|l a {b}_{M}\right|\right) … p \left(e {l}_{2} {\left|l a b\right)}_{2}\right) p \left(e {l}_{1} \left|l a {b}_{1}\right)\right) \times p \left(l a {b}_{M} \left|l a {b}_{0 : M - 1}\right)\right) … p \left(l a {b}_{2} \left|l a {b}_{1}\right)\right) p \left(l a {b}_{1} \left|s t a r t\right)\right)}{K}$$

Thus, using the system of the present disclosure, probability of any possible assignment of class labels to a sequence of elements can be evaluated in real-time time according to the values returned by the two modules.

The probability fusion module 128 may “fuse” the two probability assignments output (e.g., from the local assignment module 104 and the sequence assignment module 110) together to compute the full probability of every possible assignment of all the fields in the set. In some embodiments, the probability fusion module 128 makes a final prediction of a class of interest for each element of interest, based on the class prediction for the element by the local assignment module 104 and the probability of the predicted class following the predicted class of the previous element of interest in the sequence. In embodiments, the probability fusion module 128 may make its final prediction by applying Bayes’ theorem to the confidence scores from the local assignment module 104 and the sequence assignment module 110 and making a determination based on the resulting value. Further details about the probability fusion module may be found in co-pending U.S. Pat. Application No. ______, filed concurrently herewith, entitled “EFFICIENT COMPUTATION OF MAXIMUM PROBABILITY LABEL ASSIGNMENTS FOR SEQUENCES OF WEB ELEMENTS” (Attorney Docket No. 0101560-025US0).

The training data 102 may be a set of sample web pages, forms, and/or elements (also referred to as interface objects) stored in a data store. For example, each web page of the training data 102 may be stored as a complete page, including their various elements, and each stored element and each web page may be assigned distinct identifiers (IDs). Elements of interest may be identified in the web page and stored separately with a reference to the original web page. The IDs may be used as handles to refer to the elements once they are identified (e.g., by a human operator) as being elements of interest. So, for example, a web page containing a shipping address form may be stored in a record in a data store as an original web page, and the form-fields it contains such as first name, last name, phone number, address line 1, address line 2, city, state, and zip code may be stored in a separate table with a reference to the record of the original web page. If, at a later time, a new element of interest is identified - middle initial field, for example - the new element and the text surrounding it can be retrieved from the original web page and be added in the separate table with the reference to the original web page. In this manner, the original web pages are preserved and can continue to be used even as the elements of interest may evolve. In embodiments, the elements of interest in the training data 102 are identified manually by an operator (e.g., a human).

Once the elements of interest are identified and stored as the training data 102, it may be used by the feature transformation submodule 106 to train the machine learning model 108. The feature transformation submodule 106 may generate/extract a set of features for each of stored elements of interest. The set of features may include attributes of the interface object (e.g., name, value, ID, etc., of the HTML element) or keywords (also referred to as a “bag of words” or BoW) or other elements near the interface object. For example, text of “CVV” near a form-field may be a feature with a strong correlation to the form-field being a “card verification value” field. Likewise, an image element depicting an envelope icon with a source path containing the word “mail” (e.g., “http://www.example.com/img/src/mail.jpg”) and/or nearby text with an “@” symbol (e.g., “johndoe@example.com”) may be suggestive of the interface object being a form-field for entering an email address. Each interface object may be associated with multiple features that, in conjunction, allow the machine learning model to compute a probability indicating a probability that the interface object is of a certain class (e.g., card verification value field).

The local assignment module 104 may be a classification model implemented in hardware or software capable of producing probabilistic predictions of element classes. Embodiments of this model could include a naive Bayes classifier, a neural network, or a softmax regression model. The local assignment module 104 may be trained on a corpus of labeled HTML elements to predict the probability (e.g., p(label | features)) of each HTML element being assigned a given set of labels. These confidence scores may be indicated in the class predictions 118.

The feature transformation submodule 106 may be a submodule of the local assignment module that transforms source data from an interface, such as from the training data 102, into the feature vector 120. In embodiments, the feature transformation submodule 106 may identify, generate, and/or extract features of an interface object, such as from attributes of the object itself or from nearby text or attributes of nearby interface objects as described above. In embodiments, the feature transformation submodule 106 may transform (tokenize) these features into a format suitable for input to the machine learning model 108, such as the feature vector 120. For example, the feature transformation submodule 106 may receive the HTML of the input object, separate the HTML into string of inputs, normalize the casing (e.g., convert to lowercase or uppercase) of the inputs, and/or split the normalized inputs by empty spaces or certain characters (e.g., dashes, commas, semicolons, greater-than and less-than symbols, etc.). These normalized, split inputs may then be compared with a dictionary of keywords known to be associated with elements of interest to generate the feature vector 120. For example, if “LN” (which may have a correlation with “last name” fields) is in the dictionary and in the normalized, split inputs, the feature transformation submodule 106 may append a “1” to the feature vector; if “LN” is not present in the normalized, split inputs, the feature transformation submodule 106 may instead append a “0” to the feature vector, and so on. Additionally or alternatively, the dictionary may include keywords generated according to a moving window of fixed-length characters. For example, “ADDRESS” may be transformed into three-character moving-window keywords of “ADD,” “DDR,” “DRE,” “RES,” and “ESS,” and the presence or absence of these keywords may result in a “1” or “0” appended to the feature vector respectively as described above. Note that “1” indicating presence and “0” indicating absence is arbitrary, and it is contemplated that the system may be just as easily implemented with “0” indicating presence and “1” indicating absence, or implemented using other values as suitable. This tokenized data may be provided as input to the machine learning model 108 in the form of the feature vector 120.

To train the machine learning model 108, the feature transformation submodule 106 may produce a set of feature vectors from the training data 102, as described above. In one embodiment, the feature transformation submodule 106 may first obtain a set of features by extracting a BoW from the interface object (e.g., “bill,” “address,” “pwd,” “zip,” etc.). Additionally or alternatively, in an embodiment, the feature transformation submodule 106 may extract a list of tag attributes from interface objects such as HTML elements (e.g., title“...”). Note that certain HTML elements, such as “input” elements, may provide higher accuracy since such input elements are more standardized than other classes of HTML tags. Additionally or alternatively, in an embodiment, the feature transformation submodule may extract values of certain attributes. The values of attributes such as minlength and maxlength attributes may be useful in predicting the class of interface object. For example, a form-field with minlength=“5” may be suggestive of a zip code field. As another example, a form-field with a maxlength=“1” may suggest a middle initial field. Thus, some of the features may be visible to the user, whereas other features may not.

Additionally or alternatively, in embodiments, the features are based on text content of nearby elements (such as those whose tag name is “label”). Additionally or alternatively, in an embodiment, the features are based on the context of the element. For instance, this can be done by adding the text surrounding the HTML element of interest into the feature mixture. Near elements can be determined by virtue of being within a threshold distance to the HTML element of interest in the DOM tree or pixel proximity on the rendered web page. Other embodiments may combine one or more of the methods described above (e.g., BoW, attributes, context text, etc.).

The obtained features may then be transformed into a set of feature vectors as described above, which may be used to train a classifier. For example, each feature vector from the training data 102 may be associated with a label or ground truth value that has been predetermined (e.g., “Shipping - Full Name” field, “Card Verification Value” field, etc.), which may then be specified to the machine learning model 108. In various embodiments, the machine learning model 108 may comprise at least one of a logistic model tree (LMT), a decision tree that decides which features to use, logistic regression, naïve Bayes classifier, a perceptron algorithm, an attention neural network, a support-vector machine, random forest, or some other classifier that receives a set of features, and then outputs confidence scores for a given set of labels.

The sequence assignment module 110 may be a hardware or software module capable of returning a probability of a given sequence of elements occurring. The sequence assignment module may, with access to a corpus of sequence data in the data store 116 based on observed sequences of elements in the training data 102, determine the probability of two or more elements occurring in a given order.

The sequencer 112 may, for each interface in the set of training data 102, be hardware or software capable of extracting, from the training data 102, a set of elements in the sequence in which they occur within an interface and store this sequence information in the data store 116. The field sequences 114 may be sequence information indicating an order of occurrence of a set of elements of an interface in the training data 102.

The data store 116 may be a repository for data objects, such as database records, flat files, and other data objects. Examples of data stores include file systems, relational databases, non-relational databases, object-oriented databases, comma delimited files, and other files. In some implementations, the data store 116 is a distributed data store. The data store 116 may store at least a portion of the set of training data 102 and/or data derived from the set of training data 102, as well as the field sequences 114 of the elements of interest in the set of training data 102.

The feature vector 120 may be a set of numerals derived from features of an element of interest. In some embodiments, the feature vector 120 is a string of binary values indicating the presence or absence of a feature within or near to the element of interest in the DOM tree of the interface. The features of elements of interest in the training data 102 may be transformed into feature vectors, which are used to train the machine learning model 108 to associate features represented in the feature vector 120 with certain labels (e.g., the element of interest class). Once trained, the machine learning model 108 may receive a feature vector derived from an arbitrary element of interest and output a confidence score indicating a probability that the element of interest is of a particular class of element.

The sequence confidence scores 126 may be values indicating the probability of occurrence of two or more particular elements of interest occurring in order. For example, the sequence assignment module 110 may receive as input information indicating at least two element classes and their sequential order (e.g., first element class followed by second element class) and, based on historical data in the data store 116 derived from the training data 102, may output a value indicating a probability of this occurring based on observed sequences of element classes in the training data 102.

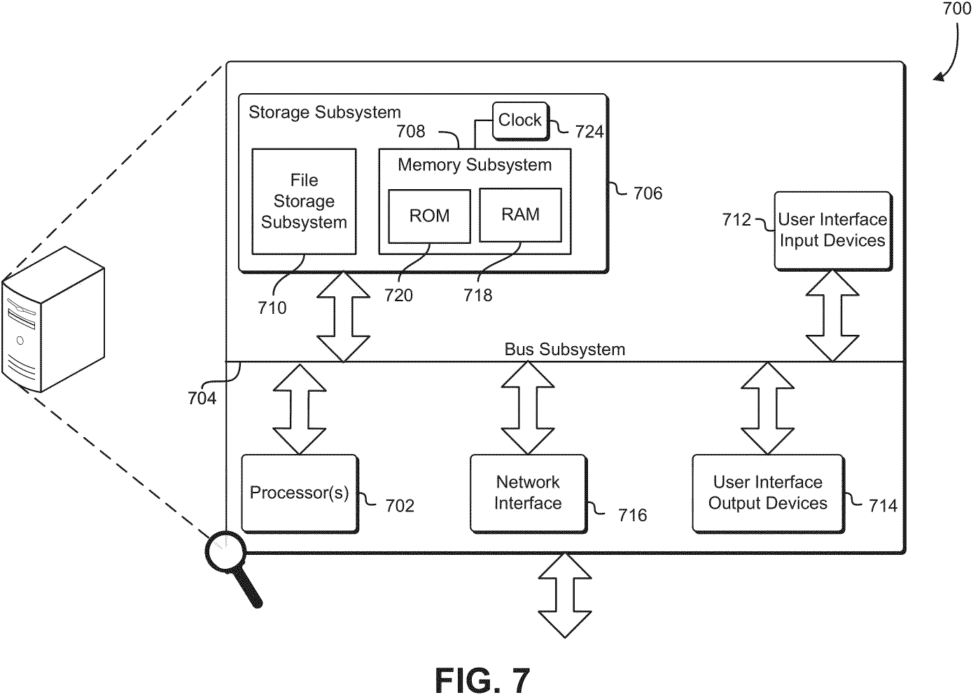

The client device 130, in some embodiments, may be embodied as a physical device and may be able to send and/or receive requests, messages, or information over an appropriate network. Examples of such devices include personal computers, cellular telephones, handheld messaging devices, laptop computers, tablet computing devices, set-top boxes, personal data assistants, embedded computer systems, electronic book readers, and the like, such as the computing device 700 described in conjunction with FIG. 7. Components used for such a device can depend at least in part upon the class of network and/or environment selected. Protocols and components for communicating via such a network are well known and will not be discussed in detail. Communication over the network can be enabled by wired or wireless connections and combinations thereof. The client device 130 may at least include a display whereby interfaces and elements of interest described in the present disclosure may be displayed to a user.

In embodiments, an application process runs on the client device 130 in a host application (such as within a browser or other application). The application process may monitor an interface for changes and may prompt a user for data to fill recognized forms on the fly. In some embodiments, the application process may require the host application to communicate with a service provider server backend and provide form-fill information, such as user data (e.g., name, address, etc.), in a standardized format. In some embodiments, the application process exposes an initialization function that is called with a hostname-specific set of selectors that indicates elements of interest, fetched by the host application from the service provider server backend. In embodiments, a callback may be executed when form-fields are recognized. The callback may provide the names of recognized input fields as parameters and may expect the user data values to be returned, whereupon the host application may use the user data values as form-fill information to fill out the form. The client device 130 may automatically fill (autocomplete) the field with the user’s first name (as retrieved from memory or other storage). In some embodiments, the client device 130 asks the user for permission to autocomplete fields before doing so.

In this manner, techniques described in the present disclosure extend form-filling functionality to unknown forms by identifying input elements within interface forms from the properties of each element and its context within the interface form (e.g., text and other attributes around the element). The properties may be used to generate a dataset based on a cross product of a word and an attribute.

The classification assignment 132 may be a set of final confidence scores of an interface element being particular classes. Based on the classification assignment 132, the client device 130 may assume that elements of interest within an interface correspond to classes indicated by the classification assignment 132. From this assumption, the client device may perform operations in accordance with the classification assignment 132, such as automatically filling a form (e.g., inputting characters into a form element) with user data that corresponds to the indicated element classes. For example, if the classification assignment 132 indicates a field element as being a first name field, the client device 130 may automatically fill the field with the user’s first name (as retrieved from memory or other storage). In some embodiments, the client device 130 asks the user for permission to autocomplete fields before doing so.

The service provider 142 may be an entity that hosts the local assignment module 104 and/or the sequence assignment module 110. The service provider 142 may be a different entity (e.g., third-party entity) from the provider that provides the interface that is automatically filled. In some embodiments, the service provider 142 provides the client device 130 with a software application that upon execution by the client device 130, causes the client device 130 to fill in form-fields according to their class in the classification assignment 132. In some embodiments, the application runs as a third-party plug-in/extension of a browser application on the client device 130, where the browser application displays the interface. Although the service provider 142 is depicted as hosting both the local assignment module 104 and the sequence assignment module 110, it is contemplated that, in various embodiments, either or both the local assignment module 104 or the sequence assignment module 110 could be hosted in whole or in part on the client device 130. For example, the client device 130 may submit source code containing elements of interest to the service provider 142, which may transform the source code using the feature transformation submodule 106, and the client device 130 may receive the feature vector 120 in response. The client device 130 may then input the feature vector 120 into its own trained machine learning model to obtain the class predictions 118.

In some embodiments, the services provided by the service provider 142 may include one or more interfaces that enable a user to submit requests via, for example, appropriately configured application programming interface (API) calls to the various services. Subsets of services may have corresponding individual interfaces in addition to, or as an alternative to, a common interface. In addition, each of the services may include one or more service interfaces that enable the services to access each other (e.g., to enable a virtual computer system to store data in or retrieve data from a data storage service). Each of the service interfaces may also provide secured and/or protected access to each other via encryption keys and/or other such secured and/or protected access methods, thereby enabling secure and/or protected access between them. Collections of services operating in concert as a distributed computer system may have a single front-end interface and/or multiple interfaces between the elements of the distributed computer system.

FIG. 2 illustrates an example 200 of a form prediction verification system of an embodiment of the present disclosure. Specifically, FIG. 2 depicts a client device 230 that sends, via a network 244, a set of class predictions 218 as input to a sequence assignment module 210, which, with reference to historical sequence information in a data store 216, responds to the client device 230 with the sequence confidence scores 226 indicating a probability that the set of class predictions 218 is correct.

Various embodiments of the present disclosure include a system that, given a set of elements in a web page (e.g., the input fields in a form or the list elements in a list) sorted according to a defined sequence (e.g., the left-to-right order in the rendered web page, depth first traversal of the DOM tree), returns a probability of a label assignment for each of the elements in the set.

The sequence assignment module 210 may be similar to the sequence assignment module 110 of FIG. 1. The sequence assignment module 210 may include the data store 216 storing sequence data for elements of interest. The sequence data may indicate the order that the elements of interest appear in an interface. In some embodiments, the order refers to the arrangement of elements on the DOM tree for the interface. A benefit of using the arrangement of the elements in the DOM tree rather than a visual order displayed on a display (e.g., a pixel-wise order) is that the order of the elements in the DOM tree are more unlikely to change if the interface is resized (e.g., to fit different sizes of displays, if a browser window’s dimensions are changed, etc.). However, it is contemplated that techniques of the present disclosure can be applied to pixel-wise ordering (e.g., left-to-right, right-to-left, top-to-bottom, multi-columned, or combinations of these, and so on).

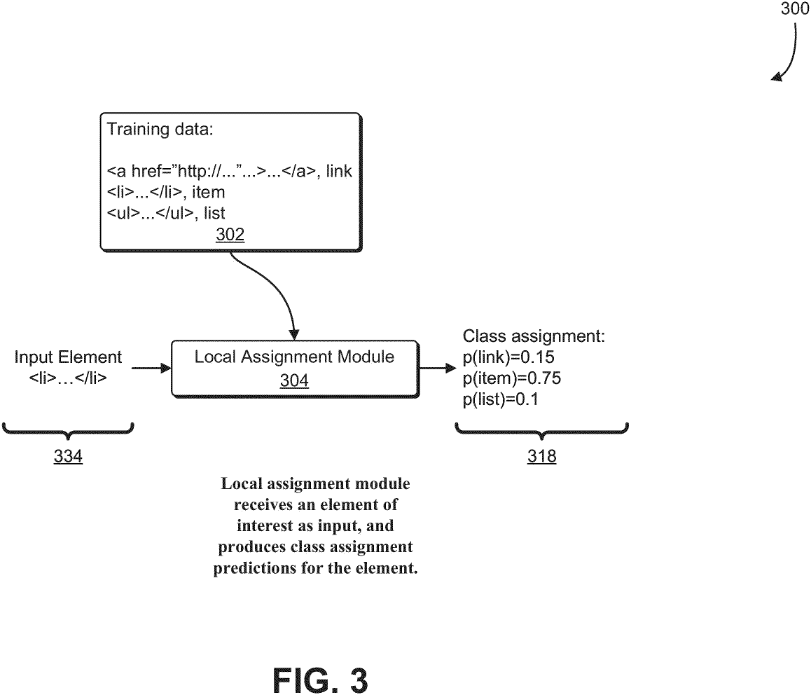

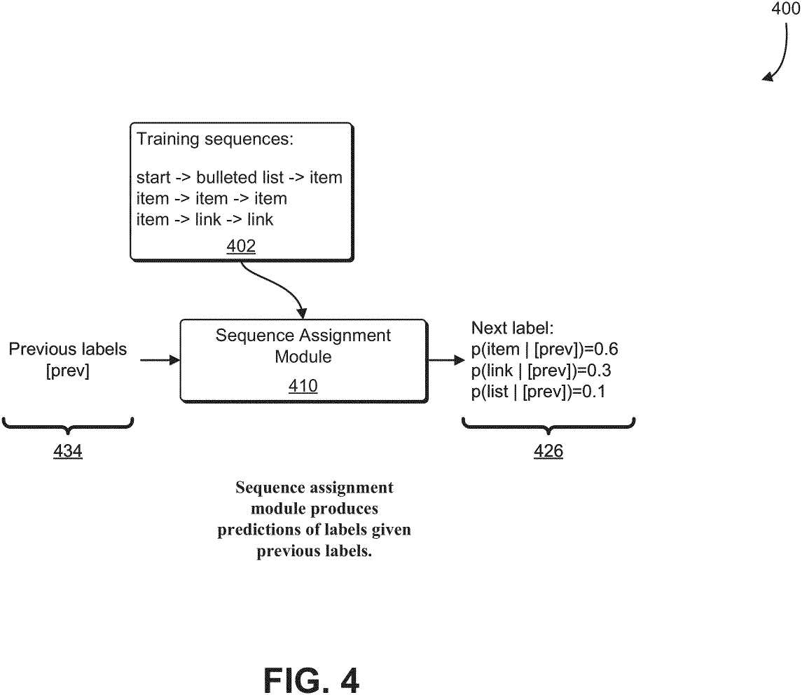

Such sequence data may be obtained from the same training data (e.g., the set of training data 102) as used to train the local assignment module 104. The sequence assignment module 210 may receive, as input, predicted classes for at least two elements of interest in sequence. Based on sequence data in the data store 216, the sequence assignment module 210 may output a probability or some other confidence score reflecting a probability that the element classes would occur together sequentially. For example, if the set of class predictions 218 includes a first predicted class (“First Name field”) and a second predicted class (“Last Name field”), as predicted for a pair of sequential form elements by a local assignment module similar to the local assignment module 104 or 304 of FIGS. 1 and 3 respectively, the sequence assignment module 110 (or the sequence assignment module 410 of FIG. 4) may output a value indicating that it is highly likely for a last name field to follow a first name field. On the other hand, if the first predicted class is predicted to be a “Telephone Number field” and the second predicted class is predicted to be a “Middle Initial field,” the sequence assignment module 304 may output a different value indicating that it is highly unlikely for a middle initial field to immediately follow a telephone number field. In this manner, form-field predictions can be graded according to their respective probabilities.

The set of class predictions 218 may be a set of predicted classes for elements of an interface, such as the class predictions 118 and the confidence scores 318 of FIGS. 1 and 3 respectively. In embodiments, the class predictions 218 are provided by a local assignment module, such as the local assignment module 104 or 304 of FIGS. 1 and 3 respectively. The class predictions 218 may include an ordering (indicating sequence) of elements corresponding to the predicted classes.

The sequence confidence scores 226 may be output from the sequence assignment module, and may indicate a probability of the sequence of the set of class predictions 218 being correct. In embodiments, if the sequence confidence scores 226 indicate, such as by a score or scores at a value relative to a threshold (e.g., at or below the threshold), that the sequence is unlikely to be correct, a form-filling process running on the client device 230 may cause the client device to not use the set of class predictions 218 in determining how to fill out a form displayed on the client device 230 and, instead, rely on the user of the client device 130 to fill out the forms. Conversely, if the sequence confidence scores 226 indicate, such as by a score or scores at a value relative to a threshold (e.g., at or above the threshold), that the sequence is likely to be correct, the form-filling process running on the client device 230 may cause the client device to auto-complete a form or prompt the user to confirm predicted element values for a form displayed on the client device 230.

The data store 216 may be similar to the data store 116 of FIG. 1. The client device 230 may be similar to the client device 130 of FIG. 1. The service provider 242 may be similar to the service provider 142 of FIG. 1. The network 244 may be similar to the network 144 of FIG. 1.

In an example, the set of class predictions 218 indicates that three sequential elements in an interface are of class A, class B, and class C respectively, and the sequence assignment module 210 is queried for a prediction as to the class of the next element in the interface. The sequence assignment module 210, with reference to the observed sequences stored in the data store 216, subsequently predicts that the fourth element is most likely to be of class D, because A, B, and C are most often followed by D in most of the observed cases in the data store 216. In some embodiments, the set of class predictions 218 (ABC) are input into the sequence assignment module 210 to obtain a prediction (the sequence confidence scores 226) of how probable the class assignments are. In one embodiment, the probability may be based on the number of times the sequence of classes A, B, and C have been observed in the data store 216. In another embodiment, the manner of determining the confidence scores involves combining a probability of an element of class A being a first element of interest in a sequence (e.g., class A has been observed to be the first element 75% of the time, class B has been observed to be the first element 25% of the time, and class C has never been observed to be the first element) with the probability of an element of class B following an element of class A (e.g., class B has been observed to follow a class A element 75% of the time, class C has been observed to follow a class A element 25% of the time, and a class A element has never been seen to follow another class A element, and so on) with the probability of an element of class C following an element of class B (e.g., class C has been observed to follow a class B element 55% of the time, class A has been observed to follow a class B element 45% of the time, and a class B element has never been seen to follow another class B element, and so on). Combined with the set of class predictions 218 from the local assignment module, the sequence confidence scores 226 may be used by the probability fusion module 128 of FIG. 1 to adjust the set of class predictions 218 to be more accurate (e.g., select a next-most likely category for one or more elements).

In another example, a form has an email field followed by a password field. A local assignment module makes a prediction (the set of class predictions 218) that the fields are actually first name and phone number fields respectively. The sequence assignment module 210 determines that a first name field is only 10% likely to be the first element of interest in a form and that a phone number field is likewise only 10% likely to follow a first name field. The combined confidence scores indicate therefore that the prediction by the local assignment module is unlikely to be correct. In some embodiments, if the combined confidence scores are too low (e.g., below a threshold), indicating that the form-field prediction is incorrect, the system of the present disclosure determines not to automatically fill out the form and, rather, gives the task of filling out the fields to the user.

FIG. 3 illustrates an aspect of a system 300 in which an embodiment may be practiced. Specifically, FIG. 3 depicts a local assignment module 304 that has been trained with training data, including training data 302. In FIG. 3, the local assignment module 304 receives an input element 334 (e.g., an HTML element) as input, and produces class assignments (confidence scores 318) for the input element 334 being particular classes.

Although, the present disclosure frequently refers to elements of interest as being form elements, it is also contemplated that elements of interest may be other classes of interface elements. This is illustrated in FIG. 3, where the elements are presented as HTML link, list item, and unordered list item elements. In the aspect of the system 300, the training data 302 include a link element (“<a href=‘http://...’...>...</a>),” a list item element (“<li>...</li>”), and an unordered list item element (“<ul>... </ul>”). Having been trained on the training examples, the local assignment module 304 receives a request to predict the class of the input element 334. Based on the training data, including the training examples, the local assignment module 304 outputs the confidence scores 318. As can be seen from the confidence scores 318, the local assignment module 304 estimates that the input element 334 is 15% likely to be a link element, 75% likely to be a list item element, and 10% likely to be an unordered list element. Thus, local assignment module 304 selects the class assignment with the highest probability - the list item at 75% - as its prediction for the class of the input element 334, and, as the input element 334 in the example is a list item element, the prediction is seen to be correct.

The training data 302 may be a set of features where each feature corresponds to a label. The local assignment module 304 may be similar to the local assignment module 104 of FIG. 104. The confidence scores 318 may be a set of confidence scores computed by the local assignment module 304, where each probability of the set indicates a probability of the input element 334 corresponding to a particular label.

The input element 334 may be an element of interest that the local assignment module 304 receives as input in order to predict the class of element it is. The input element 334 may be received by the local assignment module 304 as a set of features derived from the input element 334 properties/attributes in a manner described in the present disclosure.

FIG. 4 illustrates an aspect of a system 400 in which an embodiment may be practiced. Specifically, FIG. 4 depicts a sequence assignment module 410 that has accumulated a history of example sequences of elements, such as the previously observed training sequences 402. The sequence assignment module 410 includes a probabilistic model that computes the probability that each label comes next to any given label. The sequence assignment module 410 may be trained on a corpus of sequences of labels to predict the probability p(label | previous labels)of any label given the previous labels in the sequence (including the probability of a label being the first in the sequence).

Although the present disclosure frequently refers to elements of interest as being form elements, it is also contemplated that elements of interest may be other classes of interface elements. This is illustrated in FIG. 4, where the elements are presented as HTML link, list item, and unordered list item elements. In the aspect of the system 400, the training sequences include a first training sequence of elements comprising a start token, followed by an unordered list item element (“<ul>...</ul>”), followed by a list item element (“<li>...</li>”), a second training sequence of elements comprising three list items in a row, and a third training sequence of elements comprising a list item element followed by two link elements. In FIG. 4, the sequence assignment module 410 receives a request to predict the next class label based on the previously labeled elements 434. Based on the previously observed training sequences 402, the sequence assignment module 410 outputs the confidence scores 426.

In various embodiments, the sequence assignment module 410 is trained independently from and in parallel with the local assignment module 304 of FIG. 3. Rather than being trained on features of elements, the sequence assignment module 310 may be trained on sequences of the elements to build a data set, such as in the data store 116 of FIG. 1. For example, a plethora of real-world interface forms may be observed, and the sequences of their various form elements may be noted and stored in the data set. In this manner, a data set may be built based on interface forms and the sequences of their input fields (e.g., first name, surname, etc.).

The training sequences 402 may be a sequences of elements that have been previously observed. For example, the training sequences 402 include a sequence of elements where the first element is “start,” followed by a bulleted (unordered) list (“<ul>... </ul>”), followed by a (list) (“<li>... </li>”) item. Note that in this embodiment, “start” does not actually correspond to an element, but indicates the start of the sequence. Thus, the sequence “start -> bulleted list -> item” indicates that no element of interest occurs prior to “bulleted list,” and “bulleted list” is the first element of interest in the sequence. The training sequences 402 includes another sequence where three “item” elements of interest occur in succession. The training sequence 402 also includes a sequence where an item is succeeded by two (“<a href=... >...</a>”) links (anchors). Having been trained on the training sequences 402, the sequence assignment module 410 may produce a set of confidence scores 426 for the predictions from FIG. 3.

The sequence assignment module 410 may be similar to the sequence assignment module 110 of FIG. 1. The previous labels 434 may correspond to labels predicted by another element prediction service, such as the local assignment module 304 of FIG. 3. The set of confidence scores 426 may be computed values indicating the probibilities of a next element of interest corresponding to particular classes. As can be seen from the confidence scores 426, the sequence assignment module 410 estimates that an element of interest succeeding the previous class (“[prev]”) has a 60% probability of being a list item element, a 30% probability of being a link element, and a 10% probability of being an unordered list element.

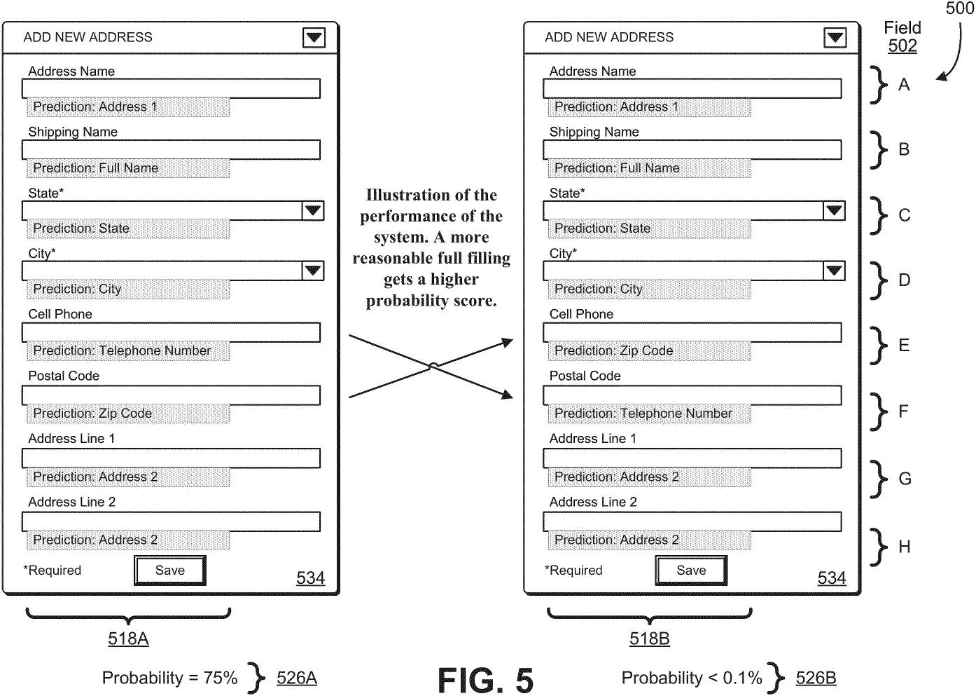

FIG. 5 described below illustrates the performance of a well-trained system. It can be seen that a “more correct” assignment receives a higher probability score than an “incorrect” one. Hence, the probability score is a good indicator of the “correctness” of a labeling choice and may be used for selecting the information for filling the form on behalf of a user. FIG. 5 illustrates an example 500 of predictions made by a sequence assignment module, such as the sequence assignment module 110 or the sequence assignment module 410 of FIGS. 1 and 4 respectively. Specifically, FIG. 5 depicts how the probability (as estimated by the sequence assignment module) that form element predictions are correct can differ due to differences in the form element predictions.

For example, the sequence assignment module receives a first set of field predictions 518A for elements of an interface form 534. As seen in the example 500, the first set of predictions predict field 1 to be an “Address 1” field, field 2 to be a “Full Name” field, field 3 to be a “State” field, field 4 to be a “City” field, field 5 to be a “Telephone Number” field, field 6 to be a “Zip Code” field, field 7 to be an “Address 2” field, and field 8 to also be an “Address 2” field. The set of predictions may have been produced by a local assignment module such as the local assignment modules 104 and 304 of FIGS. 1 and 3, respectively. The sequence assignment module may compare the sequence of the predicted fields with its history of example sequences of elements and arrive at the first predicted probability 526A that the form predictions are 75% likely to be correct. The sequence assignment module may provide this first predicted probability 526A to a form-filling application, which as a result of the high confidence that the first set of field predictions 518A is correct, may pre-populate the form-fields for the user according to the predicted field classifications. Note that a human may recognize that the predictions for fields 1 and 7 are likely incorrect, which may account for the first predicted probability being only 75% and not 100%.

Compare this with the sequence assignment module receiving a second set of predictions (e.g., from a local assignment module), where the second set of predictions predict field 1 to be an “Address 1” field, field 2 to be a “Full Name” field, field 3 to be a “State” field, field 4 to be a “City” field, field 5 to be a “Zip Code” field, field 6 to be a “Telephone Number” field, field 7 to be an “Address 2” field, and field 8 to also be an “Address 2” field. As can be seen, the simple juxtaposition of the predictions of fields 5 and 6 result in the sequence assignment module arriving at the second predicted the probability: that the second set of predictions is less than 0.1% likely to be correct. The sequence assignment module may provide this second predicted probability 526B to the form-filling application, which as a result in the low confidence in the second set of field predictions 518B, may determine not to pre-populate the form-fields for the user.

The fields 502A-02H may be elements of interest in the interface form 534. In the illustrative example 500, the fields 502A-02H include text boxes and a combo drop-down list (e.g., a combination of a drop-down list and a single-line editable textbox, allowing a user to either type a value directly or select a value from the list). However, it is contemplated that techniques of the present disclosure may be utilized with other form elements, such as a password field, radio buttons, a file select controls, a textarea fields, drop-down boxes, list boxes, combo list boxes, multi-select boxes, and the like.

The first set of field predictions 518A may be, for each of the fields 502A-02H, the most likely prediction for the field from a set of confidence scores, similar to the confidence scores 318, output by a local assignment module or some other prediction service. Likewise, the second set of field predictions 518B may be an alternate set of confidence scores, similar to the confidence scores 318, output by a local assignment module or some other prediction service. In this case, the alternate set of confidence scores of the second form prediction is different for fields 502E and 502F from the set of confidence scores of the first form prediction 518 for those fields.

The predicted probabilities 526A-26B may be, for the first set of field predictions 518A and the second set of field predictions 518B, outputs from a sequence assignment module, such as the sequence assignment module 410 of FIG. 4, indicating a probability of the fields 502A-02H occurring in the specific order predicted by a local assignment module.

The interface form 534 may be a form such as a user might encounter on any of a variety of websites. The interface form 534, for example, may be a form a website provider requires the user to complete in order to register for access to certain features or services of the website. Alternatively, the interface form 534 may be a form on a website for the user to enter information on where to deliver a product that the user may have ordered via the website.

A linear-time algorithm for probability evaluation is shown proposed in pseudocode below:

function compute _probability(filling, features, sequence _prob, feature _prob):
log_prob = 0
log_K = 0
for idx in 0...len(filling):
log_prob += feature _prob[feature[idx], filling[idx]] +
sequence _prob[feature[idx], filling[:idx]]
log_k += logsumexp(feature_prob[feature[idx], :] +
sequence _prob[:, filling[:idx]]
return exp(log_prob - log_k)

In this code, the tables sequence_prob and feature_prob contain logarithms of the confidence scores returned by the local and sequence assignment modules (which are trained on data appropriate for the specific application). Provided that there is enough training data and it is of good quality, the most likely filling will likely be the best predictor of the true filling in terms of minimum prediction error. Hence, the most accurate/confident form filling will likely be the filling with the highest probability score.

In an example, a client device, such as the client device 130 of FIG. 1, is executing an application that receives the interface form 534. The client device examines the interface form 534 to identify a set of input elements of interest. The client device may extract all of the features relevant to the classification determination for each input element of interest, including any context features from neighboring text and/or elements. In some embodiments, a local assignment module with a feature transformation submodule and a trained machine learning model, such as described in U.S. Pat. Application No. ______, entitled “SYSTEM FOR IDENTIFICATION OF WEB ELEMENTS IN FORMS ON WEB PAGES” (Attorney Docket No. 0101560-023US0), incorporated herein by reference, is executing on the client device. In such embodiments, the feature transformation submodule tokenizes those features into a feature vector for each form element of interest. The feature vectors may be individually input into the trained machine learning model, which outputs, for each form element of interest, a set of confidence scores of the form element of interest being of the possible classes. Alternatively, in some embodiments the client device provides the features to the service provider 142, which in turn tokenizes the features into feature vectors and inputs the feature vectors to a trained machine learning model executing at the service provider.

Based on the sequence of the field classes predicted for the fields 502, a sequence assignment module, such as the sequence assignment module 110 of FIG. 1, may output a value indicating a probability of the sequence being correct. An example of this is shown in FIG. 5, where, based on the sequence of the first set of field predictions 518A, the first predicted probability 526A is 75% (sequence is likely correct), whereas based on the sequence of the second set of field predictions 518B, the second predicted probability 526B is less than 0.1% (sequence is unlikely to be correct).

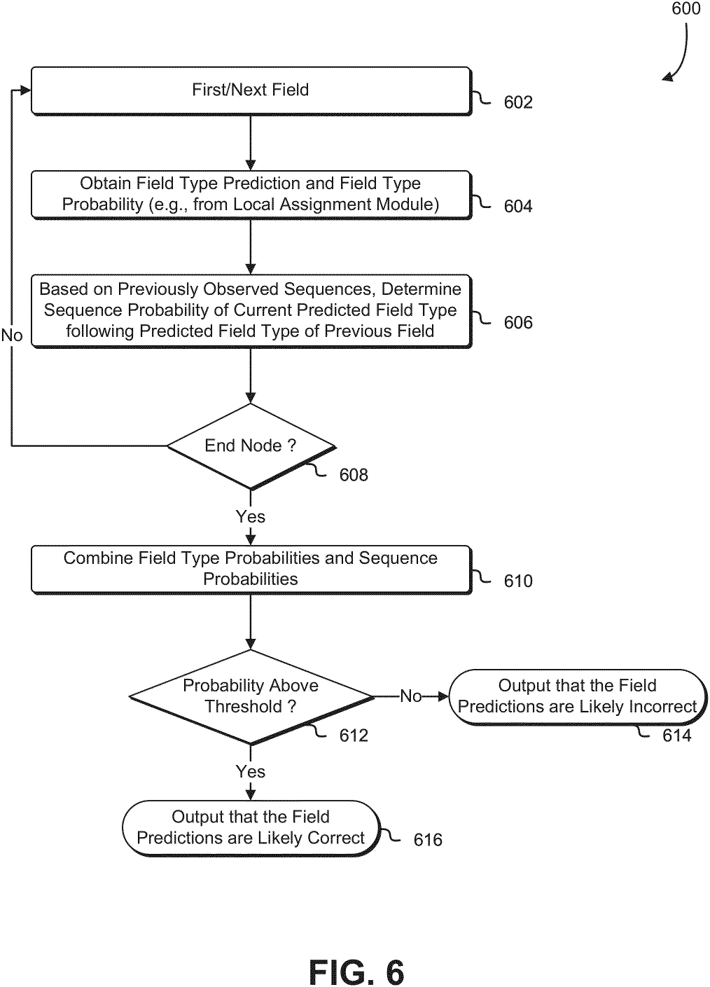

FIG. 6 is a flowchart illustrating an example of a process 600 for field sequence verification in accordance with various embodiments. Some or all of the process 600 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 700 of FIG. 7. The process 600 includes a series of operations wherein for each form-field, determine a probability of the current predicted field class succeeding a field class determined for the preceding field, and if combined confidence scores are above a threshold, output that the field predictions are likely correct; otherwise output that the field predictions are likely incorrect.

In 602, the system performing the process 600 starts with the first element of interest in a sequence of elements of interest that have been identified in an interface. An example of elements of interest may be the fields 502 of FIG. 5, other HTML elements, or the like. Predictions as to the classifications of the elements of interest having already been performed, such as by the local assignment module 104 of FIG. 1, the system obtains the predicted classification of the currently selected element of interest in 604.

In 606, the system performing the process 600 determines, based on previously observed sequences (e.g., from the training data 102 of FIG. 1), the probability that the predicted classification follows the predicted classification of the previous element of interest. If the currently selected element of interest is the first element in the sequence, the previous element of interest may be considered a “start” node. That is, in such a case, the system may determine, based on the previously observed sequences, the sequence probability that the predicted classification occurs as the first element of a sequence of elements of interest. In some embodiments, an “end” node, like the start node, may be considered a class of element of interest. In such embodiments, if the currently selected node is an end node, the system may determine, based on the previously observed sequences, the sequence probability that the previous element of interest occurs as the last element of a sequence of elements of interest. The sequence confidence scores may be stored in memory until such time in 610 they may be combined with confidence scores associated with classification predictions.

In 608, the system performing the process 600 determines if there are elements of interest remaining. For example, if the current element of interest is the end node, the sequence of elements of interest may have been fully processed and the system may proceed to 610. Otherwise, the system may return to 602 to obtain a predicted classification for the next element of interest in the sequence.

In 610, the system performing the process 600 combines the sequence confidence scores determined in 602-08 with the confidence scores associated with their respective classification predictions to determine an overall probability of the classification predictions and the sequence being correct. Any of a variety of algorithms may be applied to combine the confidence scores into an overall probability that the classifications of the sequence of elements of interest are correct, such as by multiplying the confidence scores together using Bayes’ theorem and normalizing with a K factor in the denominator (see FIG. 1). In embodiments, the K factor may be a denominator value that reflects the probability of seeing only the features such that the result of the numerator value that includes the variability of all possible labels divided by the denominator is a probability of seeing all of predicted labels given the features that have been observed.

In 612, the system performing the process 600 determines whether the overall probability is at a value relative to (e.g., meets, exceeds, etc.) a threshold. If not, the system may proceed to 614 to output that the classification predictions are unlikely to be correct. Depending on implementation, various actions may be performed as a result. For example, the system may determine not to autocomplete an electronic form because the system does not have confidence that it could correctly do so. As another example, the system may generate new predicted classifications using different criteria and perform 602-08 again with the new predicted classifications.

Otherwise, if the system performing the process 600 determines whether the overall probability is at a value relative to (e.g., meets, exceeds, etc.) a threshold, the system may proceed to 616 to output that the classification predictions are likely correct. Depending on implementation, various actions may be performed as a result. For example, the system may automatically fill out an electronic form or may prompt the user whether to fill form-fields with data corresponding to the predicted element classes.

Note that one or more of the operations performed in 602-16 may be performed in various orders and combinations, including in parallel. For example, in some embodiments, the sequence confidence scores and confidence scores associated with the classification predictions of 610 may be performed between 606 and 608.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 7 is an illustrative, simplified block diagram of a computing device 700 that can be used to practice at least one embodiment of the present disclosure. In various embodiments, the computing device 700 includes any appropriate device operable to send and/or receive requests, messages, or information over an appropriate network and convey information back to a user of the device. The computing device 700 may be used to implement any of the systems illustrated and described above. For example, the computing device 700 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 700 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 7, the computing device 700 may include one or more processors 702 that, in embodiments, communicate with and are operatively coupled to a number of peripheral subsystems via a bus subsystem. In some embodiments, these peripheral subsystems include a storage subsystem 706, comprising a memory subsystem 708 and a file/disk storage subsystem 710, one or more user interface input devices 712, one or more user interface output devices 714, and a network interface subsystem 716. Such storage subsystem 706 may be used for temporary or long-term storage of information.

In some embodiments, the bus subsystem 704 may provide a mechanism for enabling the various components and subsystems of computing device 700 to communicate with each other as intended. Although the bus subsystem 704 is shown schematically as a single bus, alternative embodiments of the bus subsystem utilize multiple buses. The network interface subsystem 716 may provide an interface to other computing devices and networks. The network interface subsystem 716 may serve as an interface for receiving data from and transmitting data to other systems from the computing device 700. In some embodiments, the bus subsystem 704 is utilized for communicating data such as details, search terms, and so on. In an embodiment, the network interface subsystem 716 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well-known and will not be discussed in detail. In an embodiment, communication via the network interface subsystem 716 is enabled by wired and/or wireless connections and combinations thereof.

In some embodiments, the user interface input devices 712 include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 700. In some embodiments, the one or more user interface output devices 714 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 700. The one or more user interface output devices 714 can be used, for example, to present user interfaces to facilitate user interaction with applications performing processes described and variations therein, when such interaction may be appropriate.

In some embodiments, the storage subsystem 706 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 706. These application modules or instructions can be executed by the one or more processors 702. In various embodiments, the storage subsystem 706 additionally provides a repository for storing data used in accordance with the present disclosure. In some embodiments, the storage subsystem 706 comprises a memory subsystem 708 and a file/disk storage subsystem 710.

In embodiments, the memory subsystem 708 includes a number of memories, such as a main random access memory (RAM) 718 for storage of instructions and data during program execution and/or a read only memory (ROM) 720, in which fixed instructions can be stored. In some embodiments, the file/disk storage subsystem 710 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 700 includes at least one local clock 724. The at least one local clock 724, in some embodiments, is a counter that represents the number of ticks that have transpired from a particular starting date and, in some embodiments, is located integrally within the computing device 700. In various embodiments, the at least one local clock 724 is used to synchronize data transfers in the processors for the computing device 700 and the subsystems included therein at specific clock pulses and can be used to coordinate synchronous operations between the computing device 700 and other systems in a data center. In another embodiment, the local clock is a programmable interval timer.

The computing device 700 could be of any of a variety of types, including a portable computer device, tablet computer, a workstation, or any other device described below. Additionally, the computing device 700 can include another device that, in some embodiments, can be connected to the computing device 700 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 700 for processing. Due to the ever-changing nature of computers and networks, the description of the computing device 700 depicted in FIG. 7 is intended only as a specific example for purposes of illustrating the preferred embodiment of the device. Many other configurations having more or fewer components than the system depicted in FIG. 7 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object-level interfaces. The computing device 700 may include any appropriate hardware, software and firmware for integrating with a data store as needed to execute aspects of one or more applications for the computing device 700 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 700 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 700 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 700 may provide the content in one or more forms including, but not limited to, forms that are perceptible to the user audibly, visually, and/or through other senses. The handling of requests and responses, as well as the delivery of content, in an embodiment, is handled by the computing device 700 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 700 typically will include an operating system that provides executable program instructions for the general administration and operation of the computing device 700 and includes a computer-readable storage medium (e.g., a hard disk, random access memory (RAM), read only memory (ROM), etc.) storing instructions that if executed (e.g., as a result of being executed) by a processor of the computing device 700 cause or otherwise allow the computing device 700 to perform its intended functions (e.g., the functions are performed as a result of one or more processors of the computing device 700 executing instructions stored on a computer-readable storage medium).

In an embodiment, the computing device 700 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 700 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 700 is capable of storing, retrieving, and accessing structured or unstructured data. In an embodiment, computing device 700 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated, and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
for each form of a plurality of electronic forms containing one or more form-fields where each of the one or more form-fields of the form corresponds to a field category:
evaluating the form to determine an ordering of classifications of the one or more form-fields; and
storing the ordering of classifications in a dataset of previously observed form-field category orderings;
obtaining information indicating:
predicted classifications of a set of form-fields of a third-party interface; and
an order of the set of form-fields;
determining, based on the information and the dataset of previously observed form-field category orderings, a probability of the predicted classifications being correct; and
as a result of the probability reaching a value relative to a threshold, providing, to a client device executing a software application, an indication of confidence whether the predicted classifications are correct.

2. The computer-implemented method of claim 1, wherein an individual form-field of the one or more form-fields is a HyperText Markup Language form element.

3. The computer-implemented method of claim 1, wherein evaluating the form to determine the ordering includes:
evaluating source code of the form to determine a Document Object Model (DOM) tree of the form; and
determining the ordering based on the order the one or more form-fields appear in the DOM tree.

4. The computer-implemented method of claim 1, wherein providing the indication of confidence to the client device causes the software application to cause the client device to autocomplete the set of form-fields of the third-party interface.

5. The computer-implemented method of claim 1, wherein:
the information further includes a set of probabilities for the predicted classifications; and
determining the probability further includes combining, in accordance with Bayes’ theorem, the set of probabilities with a probability of the predicted classifications occurring in the order.

6. A system, comprising:
one or more processors; and
memory including computer-executable instructions that, if executed by the one or more processors, cause the system to:
create a dataset of classification orderings based on previously observed interface elements in interfaces of third-party interface providers;
receive a request to evaluate a sequence of predicted classifications;
query the dataset to determine a value derived from a frequency of the sequence of predicted classifications occurring in the dataset; and
cause, by responding to the request with the value, a client device to autocomplete input to a plurality of elements corresponding to the sequence of predicted classifications if the value reaches a value relative to a threshold.

7. The system of claim 6, wherein the computer-executable instructions further include instructions that cause the system to provide, to the client device, a software application that causes the client device to submit the request to the system as a result of execution of the software application by the client device.

8. The system of claim 6, wherein at least one of the plurality of elements is a HyperText Markup Language INPUT element.

9. The system of claim 6, wherein:
the computer-executable instructions further include instructions that cause the system to obtain the plurality of elements, the plurality of elements occurring in an order in an interface; and
the sequence of predicted classifications comprise a set of predicted classifications for the plurality of elements according to the order.

10. The system of claim 9, wherein the order is based on an arrangement of the plurality of elements in a document object model tree of the interface.

11. The system of claim 9, wherein the order is based on a visual order of the plurality of elements as displayed on a display of the client device.

12. The system of claim 9, wherein the computer-executable instructions further include instructions that cause the system to determine the set of predicted classifications for the plurality of elements by, for each element of the plurality of elements:
generate, based on features of the element, a set of confidence scores for possible classifications of the element; and
determine, based on the set of confidence scores, a predicted classification for the element.

13. The system of claim 12, wherein the computer-executable instructions that cause the system to generate the set of confidence scores further include instructions that cause the system to:
derive a feature vector from the features of the element; and
obtain the set of confidence scores in response to inputting the feature vector into a machine learning model trained on the previously observed interface elements.

14. A non-transitory computer-readable storage medium having stored thereon executable instructions that, if executed by one or more processors of a computer system, cause the computer system to at least:
obtain an interface of a third-party provider, the interface including a set of interface elements;
obtain a sequence of predicted classifications for the set of interface elements;
submit, to a software application of a service provider, a request to evaluate the sequence of predicted classifications, the software application configured to determine, from a set of training data that includes a plurality of third-party interfaces, a probability of a set of interface elements occuring in a specific sequence;
receive, from the service provider in response to the request, a value based on frequency of occurrence of the sequence of predicted classifications in a dataset of orderings of classifications of previously observed interface elements in interfaces of third-party interface providers; and
as a result of the value reaching a value relative to a threshold, autocomplete input into the set of interface elements.

15. The non-transitory computer-readable storage medium of claim 14, wherein:
the interface includes an electronic form; and
the set of interface elements include a set of form-fields.

16. The non-transitory computer-readable storage medium of claim 14, wherein:
the executable instructions further include instructions that cause the computer system to obtain user-specific information corresponding to the predicted classifications; and
the executable instructions that cause the computer system to autocomplete the input further include instructions that cause the computer system to input the user-specific information into the set of interface elements.

17. The non-transitory computer-readable storage medium of claim 14, wherein the executable instructions further include executable instructions that further as a result of the frequency reaching the value, cause the computer system to cause prompt a user for confirmation whether to autocomplete the input into the set of interface elements.

18. The non-transitory computer-readable storage medium of claim 14, wherein the value is derived by combining the frequency of occurrence of the sequence with a set of probabilities for the predicted classifications in accordance with Bayes’ theorem.

19. The non-transitory computer-readable storage medium of claim 14, wherein the predicted classifications are produced as output from a neural network.

20. The non-transitory computer-readable storage medium of claim 14, wherein the executable instructions further include instructions that cause the computer system to:
obtain, in response to providing source code of the interface to the service provider, a set of feature vectors representing features of the set of interface elements; and
obtain the predicted classifications in response to inputting the set of feature vectors into a machine learning model trained to classify elements of interest.
